(19) United States
(12) Patent Application Publication
(10) Pub. No.: US 2015/0086036 A1
(43) Pub. Date: Mar. 26, 2015

(54) PACKAGING COMPONENT AND PACKAGING METHOD FOR MICROPHONE AND ELECTRONIC DEVICE

(71) Applicant: Sony Corporation, Toyko (JP)

(72) Inventor: Wenhao WANG, Beijing (CN)

(73) Assignee: Sony Corporation, Toyko (JP)

(21) Appl. No.: 14/197,685

(22) Filed: Mar. 5, 2014

(30) Foreign Application Priority Data
Sep. 25, 2013 (CN) 201310451532.2

(51) Int. Cl. H04R 1/02

(52) U.S. Cl. CPC H04R 1/025
USPC 381/91

(57) ABSTRACT

The embodiments of the present invention provide a packaging component for a microphone, a packaging method for a microphone and an electronic device. The packaging component for the microphone includes: a microphone holder configured to fix the microphone; a housing configured to package the microphone holder; and a fixing member configured to fixedly connect the microphone holder to the housing, wherein the fixing member has a via hole therethrough, and the via hole is communicated with a space of the microphone holder to form an acoustic channel of the microphone. Through the embodiments of the present invention, the problem that the conventional packaging structure cannot apply an enough force to package the microphone is solved, and the waterproof and sealing effect of the microphone is enhanced. In addition, through the packaging component, a space around the sound reception hole of the microphone can be saved.

### CROSS-REFERENCE TO RELATED APPLICATION AND PRIORITY CLAIM

This application claims priority from Chinese patent application No. 201310451532.2, filed Sep. 25, 2013, the entire disclosure of which hereby is incorporated by reference.

### TECHNICAL FIELD

The present disclosure relates to a microphone, and particularly, to a packaging component and a packaging method for a microphone and an electronic device having the packaging component.

### BACKGROUND

Currently, electronic devices, especially mobile terminals are developed rapidly, and assemblies thereof are becoming smaller in size and water-proof. With the wide application of a microphone in various electronic devices, how to reliably package a microphone becomes a challenge.

In a sealing structure of an existing microphone, a microphone holder (MIC holder) and a housing are usually bonded together by a conventional adhesive or a hook. Since an adhesive or a hook cannot push parts needing to be bonded in the sealing structure of the existing microphone, enough force cannot be applied to seal the microphone. Moreover, since an adhesive or a hook can easily age, a reliable sealing effect cannot be achieved.

### SUMMARY

Presently, the technical solution in which sealing is performed by using a fixing member, such as a screw is proposed.

To be noted, the above introduction to the technical background is just made for the convenience of clearly and completely describing the technical solutions of the present invention, and to facilitate the understanding by a person skilled in the art. It shall not be deemed that the above technical solution is known to a person skilled in the art just because it has been illustrated in the Background section of the present invention.

The inventor has found that, in the current solution in which sealing is performed by using a screw, one or more screw(s) have been added near a through-hole (also referred to as a sound reception hole) forming an acoustic channel; however, with the miniaturization of an electronic device, there is not an enough space to accommodate the screw(s) for a fixed sealing.

The embodiments of the present invention provide a packaging component and a packaging method for a microphone and an electronic device, with the object thereof being to enhance the effect of a waterproof package, and save a space around a sound reception hole of the microphone.

According to one aspect of the embodiments of the present invention, a packaging component for a microphone is provided, including:

a microphone holder configured to fix the microphone;

a housing configured to package the microphone holder; and

a fixing member configured to fixedly connect the microphone holder to the housing, wherein the fixing member has a via hole passing therethrough, and the via hole is communicated with a space of the microphone holder to form an acoustic channel of the microphone.

According to another aspect of the embodiments of the present invention, the fixing member is a self-tapping screw which has a via hole throughout an axis.

According to another aspect of the embodiments of the present invention, the self-tapping screw has a screw body and a screw head, and the screw head has a cross pattern or a line pattern.

According to another aspect of the embodiments of the present invention, the fixing member is in thread connection with the microphone holder and the housing.

According to another aspect of the embodiments of the present invention, an electronic device is provided, including a microphone, further including the packaging component for the microphone as described in the above embodiments.

According to another aspect of the embodiments of the present invention, a screw is provided, having a screw body and a screw head, further having a via hole throughout the screw body and the screw head.

According to another aspect of the embodiments of the present invention, the screw is obtained by forming a thread on the surface of a tube.

According to another aspect of the embodiments of the present invention, a packaging method for a microphone is provided, including:

forming a via hole in a fixing member; and

fixedly connecting a microphone holder to a housing by using the fixing member having the via hole, such that the via hole is communicated with a space of the microphone holder to form an acoustic channel of the microphone.

The embodiments of the present invention have the following beneficial effects: a microphone holder can be fixed by a minimum space by fixedly connecting the microphone holder and a housing using a fixing member having a via hole, which is beneficial to the miniaturization of an electronic device; moreover, the microphone holder and the housing can be reliably connected to each other through the tightening by the fixing member, which is beneficial to the waterproofing of the electronic device.

These and other aspects of the present invention will be clear with reference to the following descriptions and drawings. These descriptions and drawings specifically disclose embodiments of the present invention to reflect some ways for implementing the principle of the present invention. But it shall be appreciated that the scope of the present invention is not limited thereto. On the contrary, the present invention includes all changes, modifications and equivalents falling within the scope of the spirit and the connotation of the accompanied claims.

Features that are described and/or illustrated with respect to one embodiment may be used in the same or similar way in one or more other embodiments, and/or used by being combined with or replacing the features of other embodiments.

To be noted, the term “include/comprise” herein refers to the existence of feature, element, step or component, not excluding the existence or addition of one or more other features, elements, steps, components or combinations thereof.

Various aspects of the present invention can be better understood with reference to the following drawings. The components in the drawings are not necessarily drafted to scale, and the emphasis lies in clearly illustrating the principle of the present invention. For the convenience of illustrating and describing some portions of the present invention, corresponding portions in the drawings may be enlarged in size, e.g., enlarged to be larger than the case in the exemplary device actually made according to the present invention, relative to other portions. Parts and features illustrated in one drawing or embodiment of the present invention may be combined with parts and features illustrated in one or more additional drawings or embodiments. Moreover, in the drawings, the same reference signs denote corresponding portions throughout the drawings and may be used to denote the same or similar portions in at lest one embodiment.

### BRIEF DESCRIPTION OF THE DRAWINGS

The included drawings are used for providing further understandings of the present invention, and they constitute a part of the Specification. Those drawings illustrate the preferred embodiments of the present invention and elaborate the principles of the present invention together with the descriptions, and wherein the same element is always denoted with the same reference sign.

In the drawings:

FIG. 1 is a schematic diagram of a packaging component for a microphone according to an embodiment of the present invention;

FIG. 2 is a cross-sectional diagram of the packaging component for the microphone according to the embodiment of the present invention;

FIG. 3 is a schematic diagram of a fixing member according to the embodiment of the present invention;

FIG. 4 is a cross-sectional diagram of the fixing member according to the embodiment of the present invention; and

FIG. 5 is a flow chart of a packaging method for a microphone according to an embodiment of the present invention.

### DETAILED DESCRIPTION

The interchangeable terms “electronic device” and “electronic apparatus” include portable radio communication device, such as mobile phone, pager, communication apparatus, electronic diary, Personal Digital Assistant (PDA), smart phone, portable communication apparatus, etc.

In the present application, the embodiments of the present invention are mainly described with respect to the portable electronic apparatus in form of a mobile phone (also referred to as “cell phone”). However, it shall be appreciated that the present invention is not limited to the mobile phone, and may relate to an electronic device of any appropriate type, for example media player, game device, PDA and computer, digital camera, tablet computer, etc.

### Embodiment 1

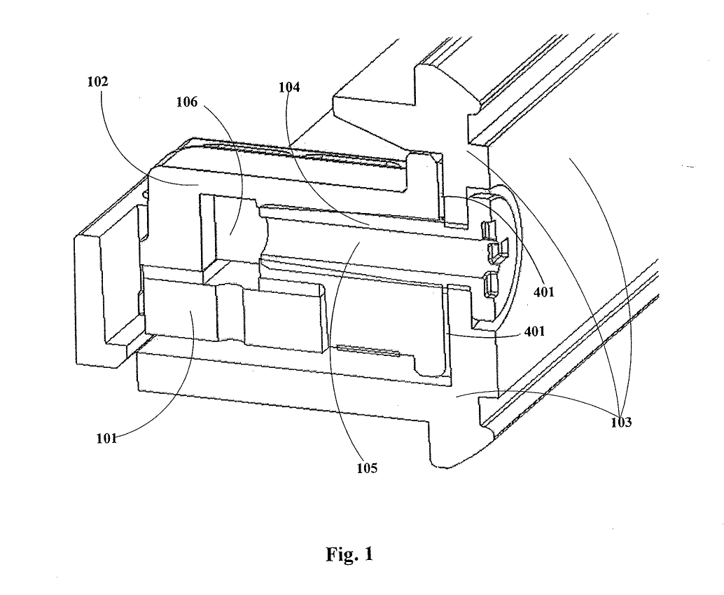

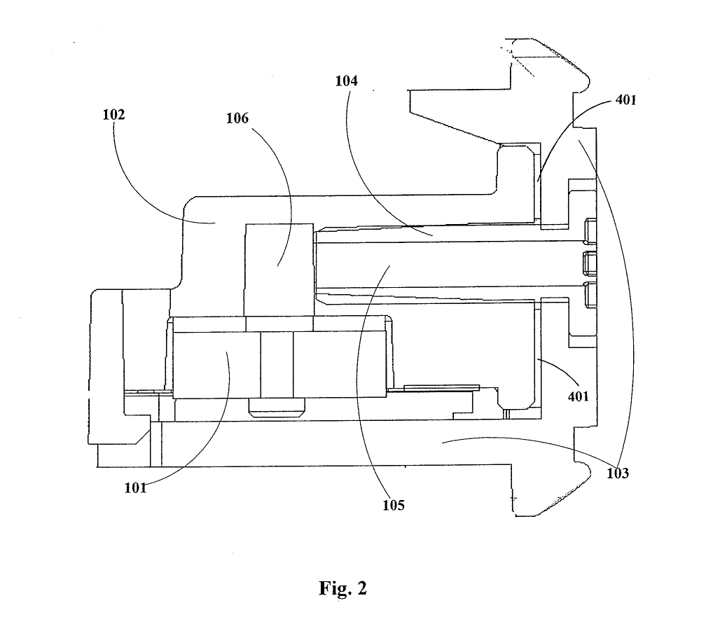

The embodiment of the present invention provides a packaging component for a microphone. FIG. 1 is a schematic diagram of a packaging component for a microphone according to the embodiment of the present invention; FIG. 2 is a cross-sectional diagram of the packaging component for the microphone according to the embodiment of the present invention; and they illustrate some constitution or structure of the packaging component for the microphone.

As illustrated in FIGS. 1 and 2, the packaging component for the microphone 101 includes:

a microphone holder 102 configured to fix the microphone 101;

a housing 103 configured to package the microphone holder 102;

a fixing member 104 configured to fixedly connect the microphone holder 102 to the housing 103, wherein the fixing member 104 has a via hole 105 passing therethrough, and the via hole 105 is communicated with a space 106 of the microphone holder 102 to form an acoustic channel of the microphone 101.

Thus, through the fixing member 104 according to the embodiment of the present invention, the microphone holder 102 may be fixed on the housing 103 to reliably connect the microphone holder and the housing, which is beneficial to the waterproof sealing of an electronic device. Moreover, the acoustic channel of the microphone 101 is formed by the via hole 105 throughout the fixing member, without requiring an additional space to form the acoustic channel. Thus, the microphone holder can be fixed by a minimum space, which is beneficial to the miniaturization of the electronic device.

In an implementation, the fixing member 104 may be a self-tapping screw which has a via hole throughout the entire self-tapping screw along an axis. In this case, the self-tapping screw of the present invention may be formed by boring a hole in a common self-tapping screw, or obtained by forming a thread on the surface of a tube.

For example, a thread may be formed on the surface of a first tube with a proper size, the first tube having the thread being taken as a screw body and a second tube with a proper size being taken as a screw head, and then the first and second tubes may be welded together to form the self-tapping screw in the present invention. But the present invention is not limited thereto, and a specific manufacturing manner can be determined according to an actual condition.

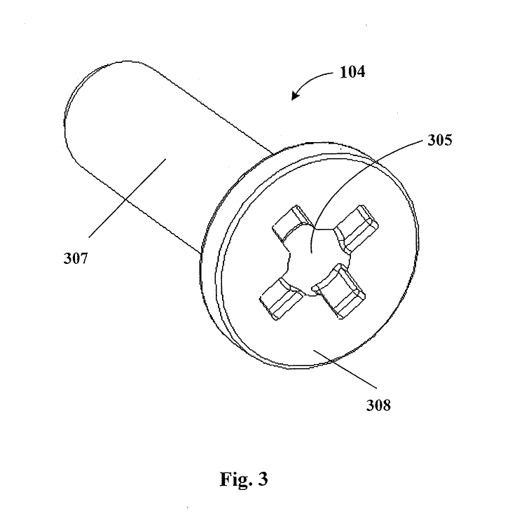

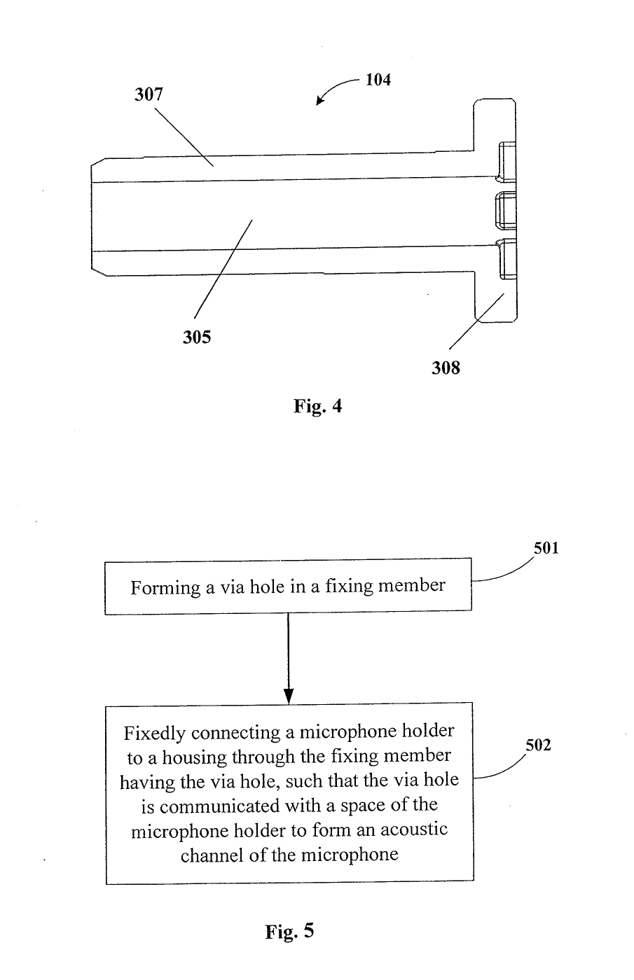

FIG. 3 is a schematic diagram of a fixing member 104 according to the embodiment of the present invention, and FIG. 4 is a cross-sectional diagram of the fixing member 104 according to the embodiment of the present invention. As illustrated in FIGS. 3 and 4, the fixing member 104 may be a self-tapping screw, which includes a screw body 307 and a screw head 308. As illustrated in FIG. 3 or 4, the self-tapping screw further includes a via hole 305 throughout an axis thereof.

Thus, by fixing the microphone holder and the housing to each other through the self-tapping screw having a via hole, it is possible to package the microphone just using a simple structure, thereby saving the space while keeping the reliability.

As illustrated in FIG. 3 or 4, the screw head 308 of the self-tapping screw 104 may have a cross pattern or a line pattern, which is beneficial to perform the fixing by using the self-tapping screw, and a relatively large force can be produced to tighten the self-tapping screw. But the present invention is not limited thereto, and a screw having a via hole and other patterns shall also fall within the scope of the present invention.

In this embodiment, the microphone 101 may first be fixed on the microphone holder 102, then the microphone holder 102 and the housing 103 are fixed to each other by using the self-tapping screw 104 having the via hole 305. Once the self-tapping screw 104 is pushed, the self-tapping screw applies a force to compact cushions 401 between the microphone holder 102 and the housing 103, and thus the microphone holder 102 and the housing 103 are securely bonded with each other. Furthermore, since the self-tapping screw has the via hole 305 throughout the axis thereof and the via hole 305 is communicated with the space 106 of the microphone holder 102 to form an acoustic channel of the microphone 101, the sound wave can enter the microphone 101.

In another implementation, the fixing member 104 may be in threaded connection with the microphone holder 102 and the housing 103. During the particular implementation, a first via hole may be formed on the microphone holder 102 and the housing 103, with a first thread (not illustrated) formed on the inner wall of the first via hole; moreover, a second thread fitted with the first thread on the inner wall of the first via hole may be formed on the outer wall of the fixing member having a second via hole 105.

Specifically, after the microphone 101 is fixed on the microphone holder 102, the microphone holder 102 and the housing 103 are fixed by using the fixing member 104 having the via hole 105. Once the fixing member 104 is pushed, the fixing member 104 applies a force to compact cushions 401 between the microphone holder 102 and the housing 103, and thus the microphone holder 102 and the housing 103 are securely bonded with each other. Furthermore, since the fixing member 104 has the via hole 105 throughout the axis thereof and the via hole 105 is communicated with the space 106 of the microphone holder 102 to form an acoustic channel of the microphone 101, the sound wave can enter the microphone 101.

To be noted, the fixing member according to the embodiment of the present invention is just schematically described through the self-tapping screw and the threaded connection. But the present invention is not limited thereto, and the specific structure may be determined according to an actual condition. In addition, the material and size of the fixing member can also be determined according to an actual demand.

Through the above embodiment, a microphone holder can be fixed by a minimum space by fixedly connecting the microphone holder and a housing using a fixing member having a via hole, which is beneficial to the miniaturization of an electronic device; moreover, the microphone holder and the housing can be reliably connected to each other through the tightening by the fixing member, which is beneficial to the waterproofing of the electronic device.

### Embodiment 2

The embodiment of the present invention provides a packaging method for a microphone, which method uses the packaging component for the microphone as described in embodiment 1. FIG. 5 is a flow chart of a packaging method for a microphone according to the embodiment of the present invention. As illustrated in FIG. 5, the packaging method includes:

Step 501: forming a via hole in a fixing member;

Step 502: fixedly connecting a microphone holder to a housing by using the fixing member having the via hole, such that the via hole is communicated with a space of the microphone holder to form an acoustic channel of the microphone.

In this embodiment, the fixing member may be a self-tapping screw, in which a via hole throughout a screw body and a screw head may be formed. Please refer to the existing machining method for the specific method of forming the via hole. In addition, a plurality of parts may also be welded or riveted together to form a fixing member having a via hole. The present invention is not limited thereto, and the specific implementation can be determined according to an actual condition.

In this embodiment, it is not required to form in advance a via hole in the microphone holder and the housing by connecting the microphone holder to the housing through the self-tapping screw having the via hole, and thus the structure is simple and easy to be applied. In addition, a via hole may also be formed in the microphone holder and the housing in advance, and a thread may be formed on the inner wall of the via hole; the microphone holder and the housing are connected to each other by the fixing member having the via hole through the thread, which facilitates the assembly and disassembly, thereby allowing the repeated use and benefiting the replacement. The present invention is not limited thereto, and the specific fixing manner can be determined according to an actual condition.

The embodiment of the present invention further provides an electronic device having a microphone and further including the packaging component for the microphone as described in Embodiment 1. The electronic device may be a mobile terminal. But the present invention is not limited thereto, and any electronic device having a microphone is suitable for the present invention.

Through the above embodiment, a microphone holder can be fixed by a minimum space by fixedly connecting the microphone holder and a housing using a fixing member having a via hole, which is beneficial to the miniaturization of an electronic device; moreover, the microphone holder and the housing can be reliably connected to each other through the tightening by the fixing member, which is beneficial to the waterproofing of the electronic device.

The preferred embodiments of the present invention are described above with reference to the drawings. Many features and advantages of those embodiments are apparent from the detailed Specification, thus the accompanied claims intend to cover all such features and advantages of those embodiments which fall within the true spirit and the scope thereof. Further, since numerous modifications and changes are easily conceivable to a person skilled in the art, the embodiments of the present invention are not limited to the exact structures and operations as illustrated and described, and they cover all suitable modifications and equivalents falling within the scope thereof.

Although a particular preferred embodiment or multiple embodiments have been illustrated and the present invention has been described, it is obvious that equivalent amendments and modifications are conceivable to a person skilled in the art in reading and understanding the description and drawings. Especially for various functions executed by the above elements (members, assemblies, apparatus, and compositions, etc.), unless otherwise specified, it is desirable that the terms (including the reference to “apparatus”) describing these elements correspond to any element executing particular functions of these elements (i.e. functional equivalents), even if the element is different in structure from that executing the function of an exemplary embodiment or multiple embodiments illustrated in the present invention. Furthermore, although a particular feature of the present invention is described with respect to only one or more of the illustrated embodiments, such feature may be combined with one or more other features of other embodiments as desired and in consideration of advantageous aspects of any given or particular application.

1. A packaging component for a microphone, comprising:
a microphone holder configured to fix the microphone;
a housing configured to package the microphone holder; and
a fixing member configured to fixedly connect the microphone holder to the housing, wherein the fixing member has a via hole passing therethrough, and the via hole is communicated with a space of the microphone holder to form an acoustic channel of the microphone.

2. The packaging component according to claim 1, wherein the fixing member is a self-tapping screw which has a via hole throughout the self-tapping screw along an axis.

3. The packaging component according to claim 2, wherein the self-tapping screw has a screw body and a screw head, and the screw head has a cross pattern or a line pattern.

4. The packaging component according to claim 1, wherein the fixing member is in thread connection with the microphone holder and the housing.

5. An electronic device comprising a microphone, further comprising the packaging component for the microphone according to claim 1.

6. A screw comprising a screw body and a screw head, further comprising a via hole throughout the screw body and the screw head.

7. The screw according to claim 6, wherein the screw is obtained by forming a thread on the surface of a tube.

8. A packaging method for a microphone, comprising:
forming a via hole in a fixing member; and
fixedly connecting a microphone holder to a housing by using the fixing member having the via hole, such that the via hole is communicated with a space of the microphone holder to form an acoustic channel of the microphone.

9. The packaging method according to claim 8, wherein the fixing member is a self-tapping screw which has a via hole throughout the self-tapping screw along an axis.

10. The packaging method according to claim 8, wherein the fixing member is in thread connection with the microphone holder and the housing.

11. An electronic device comprising a microphone, further comprising the packaging component for the microphone according to claim 2.

12. An electronic device comprising a microphone, further comprising the packaging component for the microphone according to claim 3.

13. An electronic device comprising a microphone, further comprising the packaging component for the microphone according to claim 4.
